(19) United States
(12) Patent Application Publication
(10) Pub. No.: US 2010/0074172 A1
(43) Pub. Date: Mar. 25, 2010

(54) METHOD FOR RECEPTION OF DATA PACKETS AND CORRESPPONDING TRANSMISSION METHOD

(75) Inventors: Patrick Fontaine, Rennes (FR); Charline Guguen, Bourgbarre (FR)

Correspondence Address: Robert D. Shedd, Patent Operations;THOMSON Licensing LLC, P.O. Box 5312, Princeton, NJ, 08543-5312, US

(73) Assignee: THOMSON LICENSING

(21) Appl. No.: 12/451,516

(22) PCT Filed: May 26, 2008
(86) PCT No.: PCT/EP2008/056419

§ 371 Date: Nov. 16, 2009

(30) Foreign Application Priority Data
May 24, 2007 (FR) 0755233

(51) Int. Cl. H04W 40/00

(52) U.S. Cl. 370/328

(57) ABSTRACT

the method is implemented in a first station, data packets being transmitted by at least two second stations intended for the first station, said second stations belonging to a set comprising more than one second stations, the method comprising a transmission of at least one acknowledgement of each data packet received at least once correctly, said acknowledgement(s) being transmitted to each second station of said set.

### 1. SCOPE OF THE INVENTION

The present invention relates to the wireless telecommunications domain and more precisely to the reliable transmission of data to a base station via two subscriber stations (or remote stations).

### 2. TECHNOLOGICAL BACKGROUND

According to the prior art, several wireless network architectures are known.

Some of them are based on a centralised architecture. Hence, the Wifi system (based on the IEEE 802.11a standard) has a non-centralised task scheduling architecture with a contention channel access. Such an architecture does not enable efficient management of Quality of Service (or QoS) level sufficient for some applications.

According to the patent document WO02/056534 of the prior art entitled “Automatic Repetition Request mechanism in a radio access network”, a gateway, SDUs (Service Data Unit) are segmented into PDUs and transmitted to fixed base stations, the fixed base stations transmitting the PDUs to mobile stations implementing an ARQ (Automatic Repetition Request) system. This system has the disadvantage of not being well adapted to standard equipment, the gateways being specific.

The patent document WO2005/008947 entitled “Packet retransmission for MIMO systems using multipath transmission” discloses a network with multiple repeaters and using negative acknowledgements or NACK. This system has the disadvantage of not ensuring a sufficient level of reliability for communications.

The Wimax system (based on the IEEE 802.16 standard) possesses a centralised scheduling architecture, which allows the implementation of a more appropriate quality of service for certain applications (maximum delivery time for a packet (typically 5 ms) and bandwidth guaranteed for each connection request).

Nevertheless, the techniques implemented in the Wimax networks do not enable a quality of service to be guaranteed for all the applications, for example for video type communications, data being received by wireless cameras moving around in noisy radio-frequency environments, subject to interference or disturbed by obstacles creating signal losses or echoes. Hence, a communication with a wireless station can be cut off suddenly (for example, when the mobile station is moving around). Indeed, the support or the coverage of a wireless link cannot be guaranteed, which may cause reception problems when a station or its environment moves.

### 3. SUMMARY OF THE INVENTION

The purpose of the invention is to overcome the disadvantages of the prior art.

More particularly, the purpose of the invention is to enable the reception of data by at least one wireless station from relay stations, with a guaranteed quality of service and more specifically with an absence of cutting off of the communication (namely, with no loss of packets having to be received by the wireless station or stations) under normal conditions of use.

The invention relates to a method being implemented in a first station, each data packet (PDU) being transmitted by at least two second stations intended for the first station, the second stations belonging to a set comprising several second stations. In order to guarantee the quality of service in normal use conditions, the method comprises a transmission of at least an acknowledgement of each data packet, the packet being received at least once correctly, the acknowledgement or acknowledgements being transmitted to each second station, advantageously, the data packets are from at least one service data unit (SDU) packet, the division of the service data unit packet and the numbering of the data packet(s) by each of the second stations being identical.

The data packets or PDU correspond to an active layer and the service packet units or SDU correspond to packets of a layer higher than the active layer.

Thus, the data packets are prepared and transmitted in parallel by a plurality of second stations, which makes reliable the reception of these data by the first station. In addition, the SDU being prepared by the second stations, the source or intermediary items of equipment can be standard equipment.

According to a particular characteristic, the method comprises a request for retransmission of at least one data packet to at least one second station and, advantageously, each of the second stations, when the data packet(s) have not been correctly received.

According to another particular characteristic, the data packet or packets are in the medium access control communication layer called MAC layer.

Advantageously, the method comprises an assembly step of more than one packets received in an SDU or application packet.

According to a specific characteristic, the data packets received come from at least two distinct second stations.

Advantageously, each data packet is transmitted to the first station by each of the second stations.

According to a particular characteristic, each packet is transmitted on a wireless link between the second stations and the first station, for example according to the IEEE 802.16 protocol.

According to an advantageous characteristic, the method comprises a transmission to a device of at least one service packet comprising the data corresponding to a received data packet, said at least one service packet comprising the control information of said device.

According to another advantageous characteristic, the method comprises a transmission to a device of at least one service packet comprising the data corresponding to at least one received data packet, the device being adapted to capture audiovisual data.

The invention also relates to a method for transmission of data packets to a first station, the method being implemented in a second station, each packet being transmitted by at least two second stations intended for a first station. In order to guarantee the quality of service in normal use conditions, the method comprises:
a division of at least one service packet unit (SDU) in at least one packet data unit (PDU) by at least two second stations, the division and numbering of the data packet(s) being identical in each of the second stations,
a transmission of data packet(s) intended for the first station, and
a reception of a first acknowledgement of at least one data packet transmitted, the acknowledgement being transmitted by the first station.

Thus, the reception of the first acknowledgement enables each second station having received this acknowledgement to eliminate the corresponding data packet, even if the first station has received this data packet from another second station.

In addition, the synchronization between the second stations is maintained, even if the packet is not transmitted (for example) if the buffers of the second station receiving the packets and implementing the method are full.

According to a particular characteristic, at least one of the second stations transmits a second acknowledgement corresponding to the first acknowledgement to each of the other second stations.

Thus, when the link between the second station and the first station is not reliable, the second station receiving a second acknowledgement does not need to retransmit the acknowledged data packet.

The invention also relates to a method for reception of packets of data, the system comprising a first station, each data packet being transmitted by at least two second stations intended for the first station, the second stations belonging to a set comprising several second stations. The system comprises the means for transmission of at least an acknowledgement of each packet received at least once correctly, the acknowledgement or acknowledgements being transmitted to each second station of the set.

Advantageously, the system comprises a device receiving the packets via a first station. The device and the first station can be in separate items of equipment or in the same item of equipment.

According to a particular characteristic, at least a part of the packets comprise device control information.

According to a particular characteristic, the device is adapted to capture audiovisual data.

### 4. LIST OF FIGURES

The invention will be better understood, and other specific features and advantages will emerge upon reading the following description, the description making reference to the annexed drawings wherein:

FIG. 1 illustrates an example of a communication network architecture with elements implementing the invention,

FIGS. 2 and 3 diagrammatically show, respectively, a mobile wireless station and a relay station belonging to the network of FIG. 1, according to a particular embodiment of the invention,

FIGS. 4 and 5 show an implementation method in the wireless station of FIG. 2, according to particular embodiments of the invention;

FIGS. 6 and 7 show an implementation method in the relay station of FIG. 3, according to particular embodiments of the invention;

FIG. 8 illustrates an example of communication between different network elements of FIG. 1, and

FIG. 9 provides an example of frames exchanged by the network elements of FIG. 1.

### 5. DETAILED DESCRIPTION OF THE INVENTION

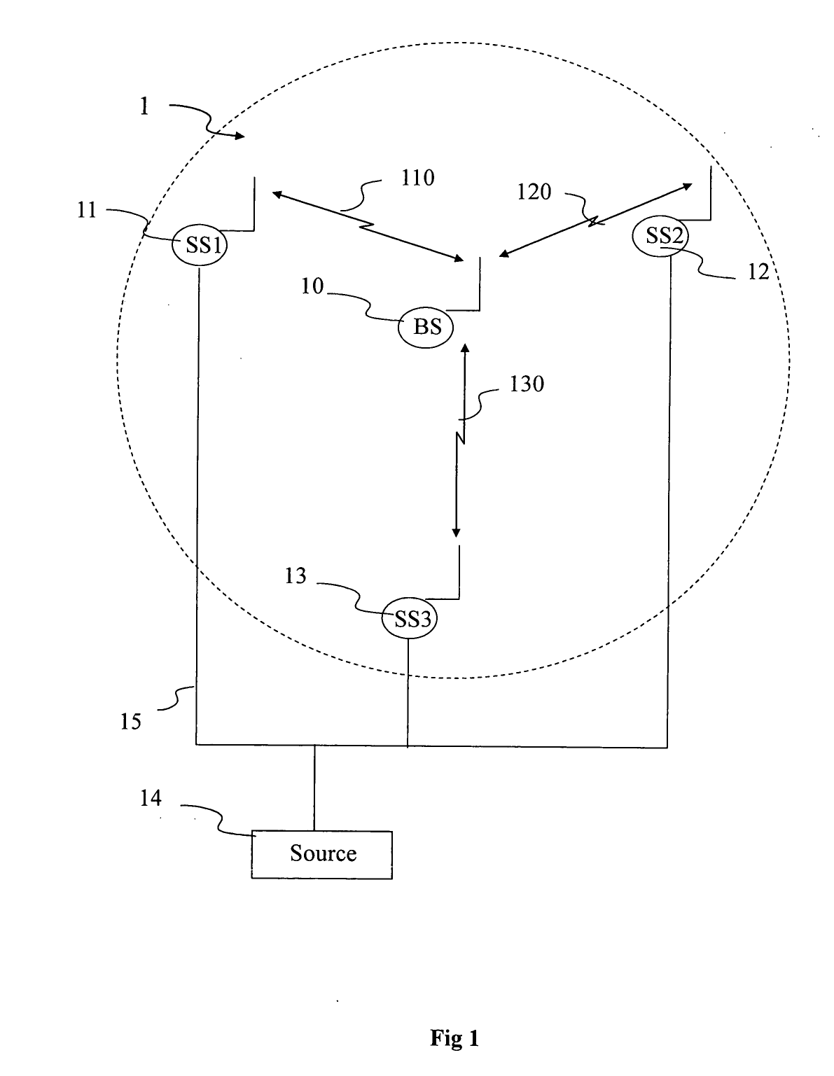

FIG. 1 shows a communication network comprising a wireless network 1 and a wired Ethernet network (or IEEE 802.3).

The wireless network 1 comprises one or more wireless stations, fixed or, advantageously, mobile. A wireless station is for example a base station (or BS) BS 10. If there are more than one base stations, they use different physical channels (for example, frequency channels or CDMA (“Code Multiple Division Access”), temporal allocations or TDMA (“Time Division Multiple Access”)).

The Ethernet network comprises a source node 14.

The base station 10 can transmit or receive data intended for (for example images) or coming from (for example control data) the node 14 via relay stations or subscriber stations (SS standing for “Slave Stations” or RS standing for “Remote Stations”) SS1 11, SS2 12 and SS3 13 (second stations of the wireless network). The subscriber stations 11 to 13 enable the interface between the wireless network 1 and the Ethernet network to be assured. Thus, the subscriber station 11 (12, 13 respectively) is connected via a bidirectional wireless link 110 (120, 130 respectively) to the base station 10. The network architecture 1 is such that the network 1 comprises enough subscriber stations to cover the entire zone in which the base stations are likely to be found. Hence, at any time, each base station of the network 1 is connected to at least one client station by a wireless link enabling wireless communication to be assured. The subscriber stations 11 to 13 are connected directly or via a hub by an Ethernet 15 link (or any other network enabling the transmission and the reception of data) to the node 14. According to a variant, they are also connected to each other via an Ethernet link (or any other type of wired or wireless link). Thus, for example, if the base station 10 is connected to the subscriber station SS1 11, it can receive the data transmitted by the node 14 via the links 15 and 110.

The base station or stations are for example mobile cameras, equipped with wireless communication means and the node 14 is an image processing system (for example, a video recorder, a studio entry point etc.). Hence, the network of FIG. 1 enables a continued transmission (i.e. without interruption) of control data by a processing system to cameras located on the interior or the exterior of buildings for retransmitting any event (for example a sporting event or a show) over an equally nondescript geographic zone. The base station can be comprised or be associated within a data packet reception system to a device and adapted to capture audiovisual data (for example, camera), the base station transmitting the packets received from the device. These packets comprise, for example, control information from the device.

Advantageously, the subscriber stations share a same radio frequency channel, the radio spectrum being a resource to be economised. The subscriber stations can possibly listen mutually to each other on the radio channel. According to a variant, the subscriber stations cannot listen mutually to each other on the radio channel.

Advantageously, the communications implemented between the nodes of the network of FIG. 1 are of the IP type (Internet Protocol), the SS, the BS and the node 14 each having an IP address. IP is used to transport the flow in streaming mode, for example for transporting video and/or audio in unidirectional or bidirectional mode.

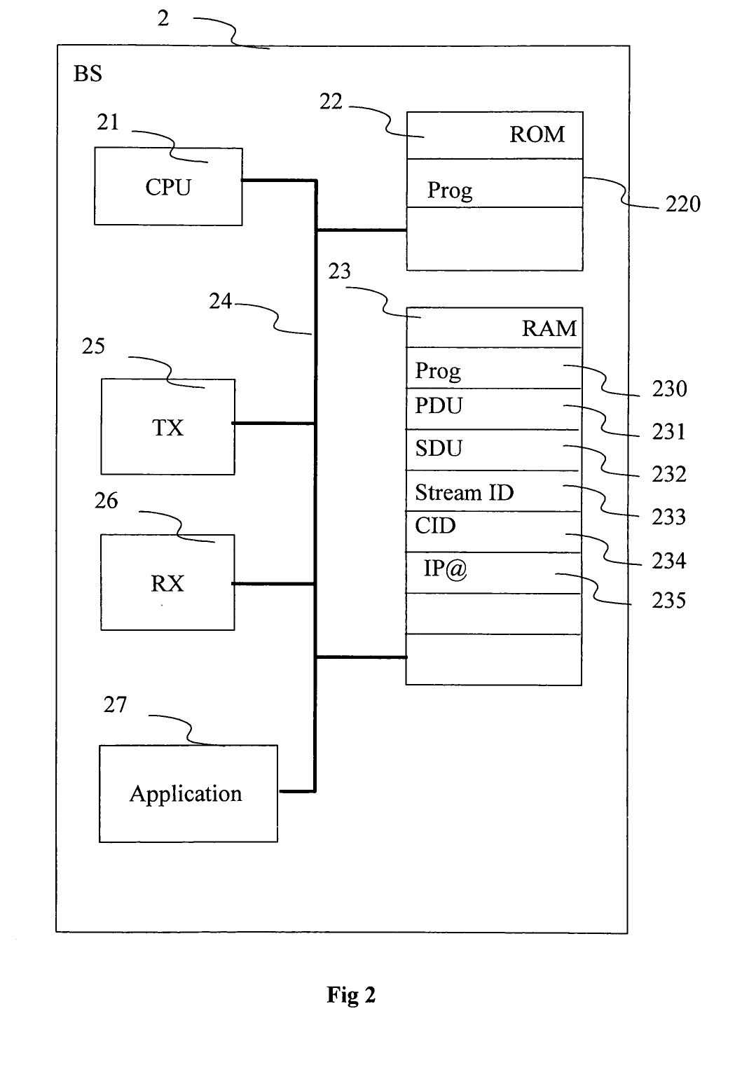

FIG. 2 diagrammatically illustrates a mobile station 2 of the network 1 corresponding to the base station 10. The mobile station 2 comprises, connected to each other by a bus 24 addresses and data, also transporting a clock signal:
a microprocessor 21 (or CPU),
a non-volatile memory of ROM (Read Only Memory) type 22,
a Random Access Memory or RAM 23,
a transmission module 25 of a signal on the wireless link,
a reception module 26 of a signal on the wireless link, and
an interface 27 to an application.

It is noted that the word “register” used in the description of memories 22 and 23 designates in each of the memories mentioned, a memory zone of low capacity (some binary data) as well as a memory zone of large capacity (enabling a whole programme to be stored or all or part of the data representing an audio/video service received).

The application is, for example, of video type and constitutes respectively the source and destination of the data respectively transmitted and received by the mobile station 2 (the mobile station 2 is for example a camera or a radio system associated with a camera).

The ROM memory 22 notably comprises a programme “prog” 220.

The algorithms implementing the steps of the method specific to the invention and described below are stored in the ROM 22 memory associated with the mobile station 2 implementing these steps. When powered up, the microprocessor 21 loads and runs the instructions of these algorithms.

The random access memory 23 notably comprises:
in a register 230, the operating programme of the microprocessor 21 responsible for switching on the mobile station 2,
the data or the PDUs (“Packet Data Unit”) corresponding to the data packets of level 2 or MAC (“Medium Access Control”) containing this data in a register 231,
data packets of type SDU (“Service Data Unit”) being able to contain several PDUs in a register 232
an SID (“Stream ID”) flux identifier in a register 233, the SID identifier enabling the classification to be made (“classifier” function according to the IEEE 802.16 standard);
one or more connection identifiers or CID in a register 234, and
an IP address of the mobile station 2 in a register 235.

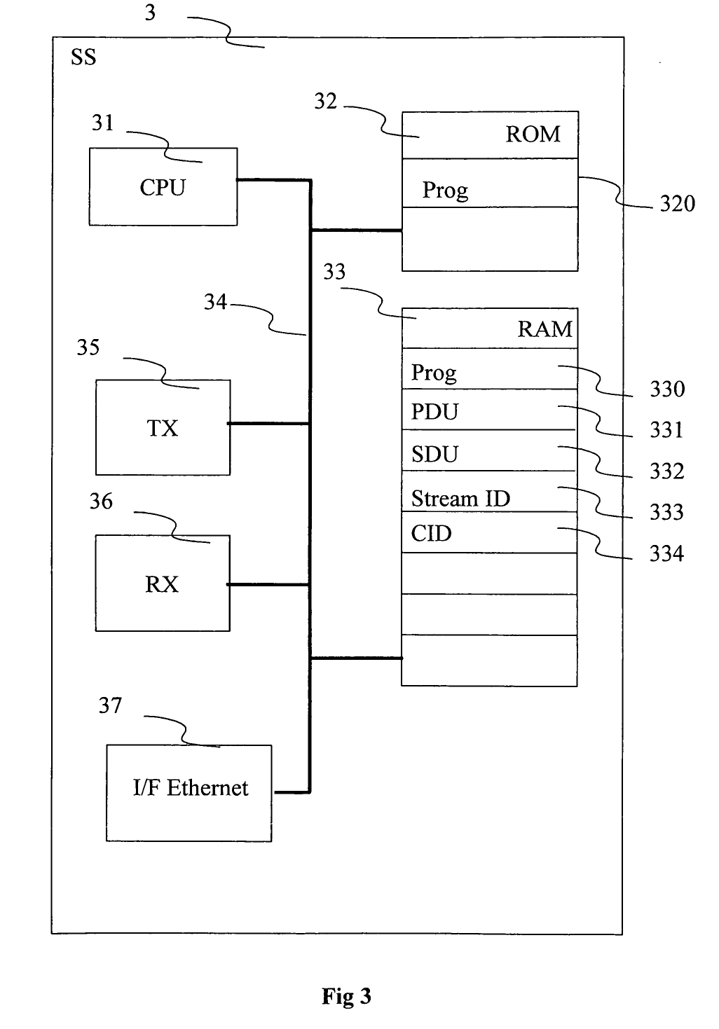

FIG. 3 diagrammatically illustrates a subscriber station 3 of the network 1 corresponding to SS1, SS2 or SS3.

The subscriber station 3 comprises, connected to each other by an address and data bus 34, also transporting a clock signal:
a microprocessor 31 (or CPU),
a non-volatile memory of ROM (Read Only Memory) type 32,
a Random Access Memory or RAM 33,
a transmission module 35 of a signal on the wireless link,
a reception module 36 of a signal on the wireless link, and
an interface 37 to an Ethernet network.

It is noted that the word “register” used in the description of memories 32 and 33 designates in each of the memories mentioned, both a memory zone of low capacity (some binary data) and a memory zone of large capacity (enabling a whole programme to be stored or all or part of the data representing an audio/video service received).

The ROM memory 32 notably comprises a programme “prog” 320.

The algorithms implementing the steps of the method specific to the invention and described below are stored in the ROM 32 memory associated with the subscriber station 3 implementing these steps. When powered up, the microprocessor 31 loads and runs the instructions of these algorithms.

The random access memory 33 notably comprises:
in a register 330, the operating programme of the microprocessor 31 responsible for switching on the subscriber station 3,
data or PDUs containing this data in a register 331,
data packets of SDU (“Service Data Unit”) type being able to contain several PDUs in a register 332,
a stream identifier in a register 233,
a connection identifier or CID in a register 234, and
an IP address of the mobile station 2 in a register 235.

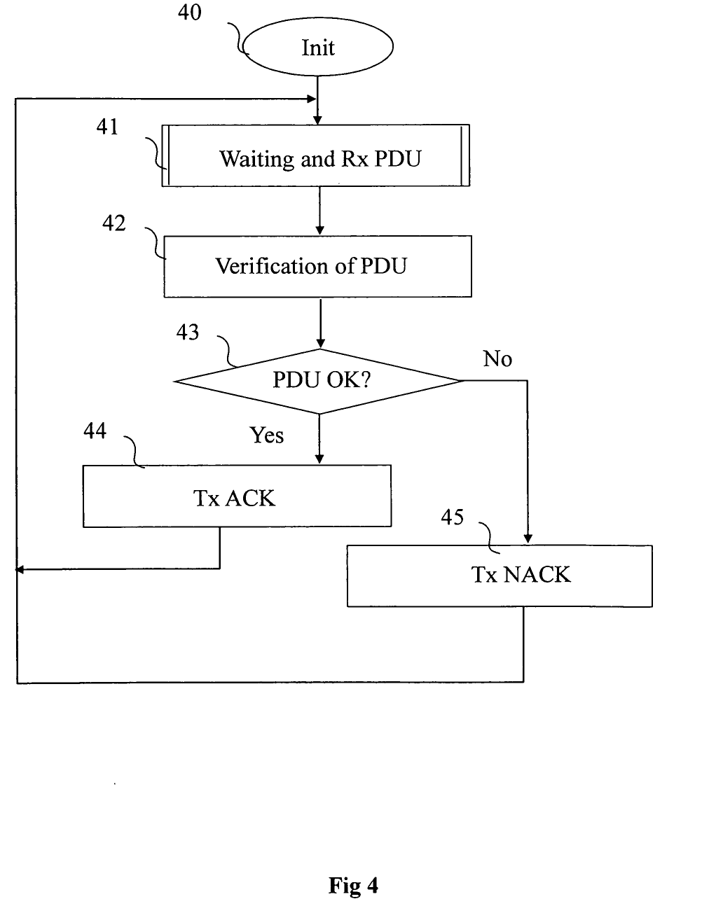

FIG. 4 shows a method used in the wireless station 2 according to a particular implementation of the invention.

This method begins with an initialisation phase 40 during which the different parameters of the station 2 are updated.

Then, during a step 41, the station 2 waits then receives at least one PDU from one or more subscriber stations 11 to 13, each subscriber station transmitting a PDU with the same data useful to the application.

Then, during a step 42, the station 2 checks that the PDU transmitted by each of the subscriber stations 11 to 13 is received correctly (for example, by checking an error detection code present in the received PDU).

Then during a test 43, the station 2 checks that at least one of the PDUs transmitted by the subscriber stations has been correctly received.

When this is the case, the station 2 transmits a positive acknowledgement or ACK of level 2 (MAC layer) indicating a correctly received PDU, at each of the subscriber stations 11 to 13. The corresponding PDU is transmitted to the application and step 41 is repeated. If a same PDU transmitted by at least two different subscriber stations is correctly received, it can be duplicated and, advantageously, the PDU is transmitted once to the application.

If for a given PDU, the station 2 does not correctly receive the corresponding PDU transmitted by the subscriber stations, the station 2 transmits a negative acknowledgement or NACK identifying the incorrectly received PDU, to each of the subscriber stations 11 to 13. Step 41 is then repeated.

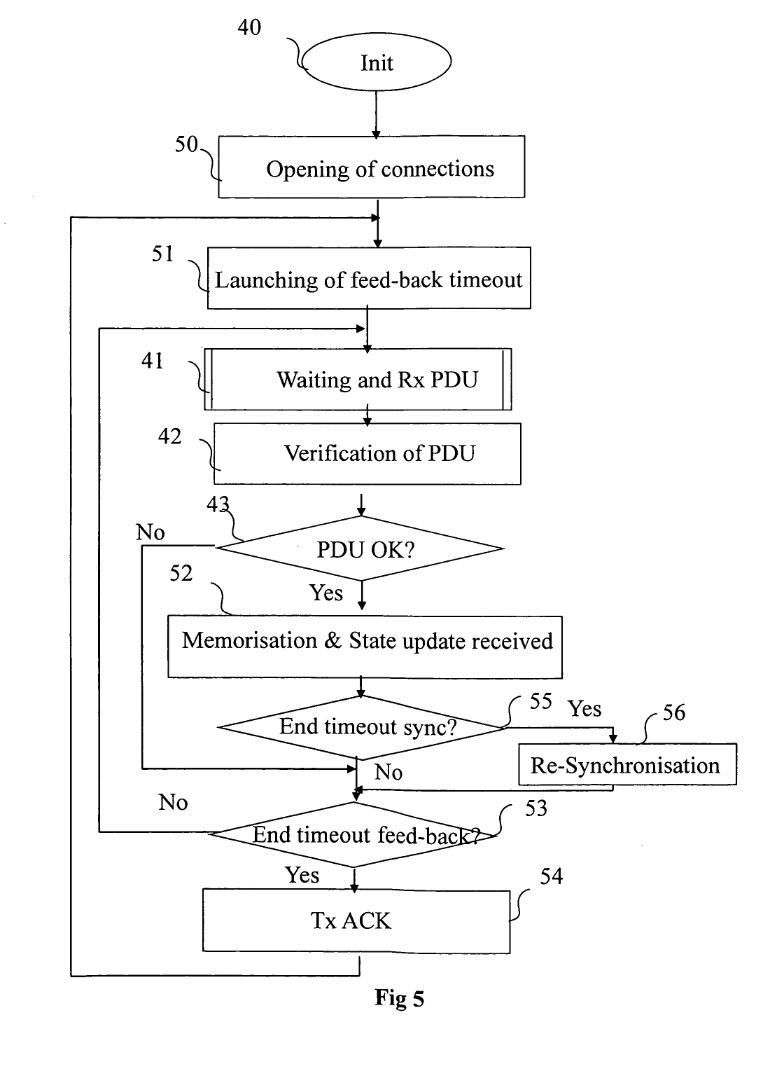

FIG. 5 shows a method implemented in the wireless station 2 according to a particularly advantageous implementation of the invention, in the context of a wireless network comprising notably standard subscriber stations 11 to 13, compatible with the IEEE 802.16 standard. The steps in common with the method illustrated in FIG. 4 have the same references and are not described in further detail.

Following an initialisation step 40, during a step 50 the station 2 opens a connection associated with each subscriber station 11 to 13. Three connections (one connection per subscriber station) are thus created with the same parameters (for example, the bitrate, the latency, ARQ parameters and classification (SID) parameters) but with different CID (Connection IDentifier) identifiers. This enables functioning with standard subscriber stations, the base station being adapted to the implementation of the invention. Thus each SS of network 1 is connected to the BS.

According to a variant, the station 2 controls the connections associated with several streams, these streams being able to correspond to the different data types and/or the distinct sources. Each of the streams is identified by a SID which is specific to it and transmitted on specific connections (two connections on two separate streams are differentiated).

Following this step, each SS can transmit PDUs to the BS with a noticeably synchronous numbering. During the first transmission, the number of the first PDU for each SS is the same. Each SS is configured to divide the SDUs into PDUs and number the PDUs in the same way (for example same size PDUs and same start number). If a SS enters the network 1 later, the network is reinitialized (stream stoppage, flushing of buffers, re-initialization of connections, then re-start of streams), a connection will also be open for this SS with an initialization of PDU numbers in phase with the current numbering of PDUs transmitted by the other SS. According to a variant, when an SS enters later into a network 1, a synchronization mechanism between SS enables an identical numbering of the PDUs transmitted by the SS with those SS that are already connected. For example, the SS's buffers are flushed without transmitting the new SDUs arriving during the resynchronization and recommencing the numbering in a synchronous manner (order or synchronization message transmitted by the BS or exchanged on the wire connection) on the first SDU arriving after this order. Advantageously, the method implemented by the BS comprises a detection of a loss of synchronization in the numbering of received PDUs, according to this variant, the BS verifies systematically, randomly, periodically or following any event, if two data packets transmitted by two SS and carrying the same number comprise the same content. If this is not the case, an error is detected and the BS transmits a message for re-synchronization of the numbering of packets directly to the SSs or to an item of network control equipment.

Then, during a step 51, a feedback timeout is launched.

Next, the steps 41 of PDU reception, 42 of verification and 43 of test are carried out.

If this is the case, during a step 52, each correctly received PDU is memorised, transmitted to the application and the corresponding PDU status in the PDU descriptor is updated (the status switches from “not received” to “received”). If the same PDU is received several times in the correct manner, the duplicates are eliminated. Advantageously, the PDUs are transmitted to the application after reconstruction of an entire SDU comprising the corresponding PDUs. According to the invention, a SDU can be constructed with the PDUs from different SSs.

According to a particular embodiment, synchronisation timeouts are implemented for each connection and for each connection, an ARQ reception window defines the first incorrectly received PDU. For a given connection, if the first incorrectly received PDU changes, then the synchronisation timeout associated with this connection is reset.

Then, during a test 55, for each connection it is verified that the synchronization timeout has attained a determined limiting value (for example 100 ms).

If this is the case (timeout limit value reached), during a step 56, the station 2 transmits to the corresponding SS a re-synchronization order with the first number of the non-received PDU. This enables the corresponding SS to re-transmit the PDUs in a noticeably synchronous way with the other SSs, and to have an ARQ transmission window synchronous with the SS associated ARQ reception window in the BS.

According to a variant, the station 2 does not implement the synchronisation timeouts and therefore neither the test 55 nor the step 56.

Following a negative result of the test 55 (synchronisation timeout value not reached) of step 56, or a negative result of test 43, the CPU 21 checks during a test 53 whether the feedback timeout launched in the step 51 is passed. The maximum value is for example comprised between 2 and 10 ms. If this is not the case, the step 41 is repeated. According to a variant, a full memory test and/or verification if the number of identical PDUs received corresponds to the number of SSs can replace or can be added to test 53. Advantageously, the nature of the test 53 depends upon the application: for example for a file transmission, a full memory test can be advantageously implemented, for a video transmission, an adapted timeout can be implemented.

If the result of the test 53 is positive, the timeout is passed and an acknowledgement (ACK) procedure and/or Automatic Retransmission Request (ARQ) is implemented. According to the invention, during a step 54, if a PDU transmitted by the SSs is correctly received, then the station 2 transmits a positive acknowledgement or ACK to all of the SSs (a same PDU is transmitted by all the SSs, the ACK is transmitted as soon as at least one PDU transmitted by an SS is correctly received by the BS). It concerns an essential difference with the implementations of IEEE802.16 networks according to the prior art that do not provide such procedures, a single connection being used in transmission to a single destination (there is no transmission to a plurality of destinations (multicast) with ARQ). According to a variant of the invention, if the station 2 does not correctly receive any packet corresponding to a same PDU transmitted by all the SSs then the station 2 transmits a negative acknowledgement or NACK. An ACK acknowledgement associated with a PDU identified by its number corresponds to a logical “OR” of the reception status of each PDU carrying the same identification number and transmitted by the SSs. The acknowledgement feedbacks are transmitted to all the SSs on being duplicated for each connection (that is to say the corresponding CIDs). According to the embodiment mode described here, the acknowledgement is selective. According to a variant, the acknowledgement is cumulative: several acknowledgements corresponding to consecutive PDUs are cumulated; an acknowledgement corresponding to the last of the correctly received consecutive PDUs is transmitted to all the SSs. According to another variant, the acknowledgements are both cumulative and selective. the BS indicates the last correctly received PDU of a sequence of correctly isolated PDUs and correctly received after the last correctly received PDU cumulatively.

According to a variant, the test 53 and step 54 are carried out in parallel with step 41 (for example in multi-task environment).

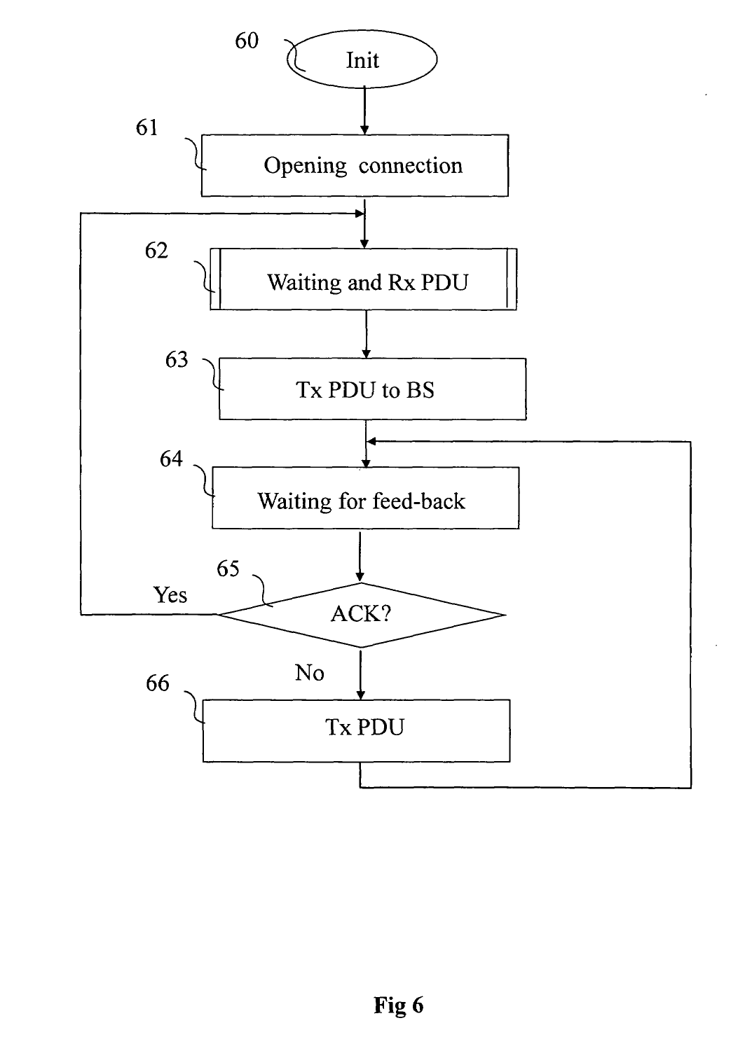

FIG. 6 shows a method implemented in the station 3 according to a particular implementation of the invention.

This method begins with an initialisation phase 60 during which the different parameters of the station 3 are updated.

Then, during a step 61, a connection is opened with the base station.

Then, during a step 62, the station 3 waits for and receives at least one PDU from the source 14. The source 14 transmits to all the SSs, the PDU to be transmitted to the base station.

Then, during a step 63, the station 3 numbers each PDU and transmits them in one or more bursts to the base station.

Then, during a step 64, the station 3 waits for a return from the base station. According to a variant, the waiting period is limited by a timeout launched during step 63.

Then, during a test 65, the station 3 verifies if a positive acknowledgement has been received. In the affirmative case, the step 62 is repeated.

In the negative case (no positive acknowledgement has been received or a negative acknowledgement (NACK) has been received), during a step 66 the non acknowledged PDU or PDUs are retransmitted to the BS and step 64 is repeated.

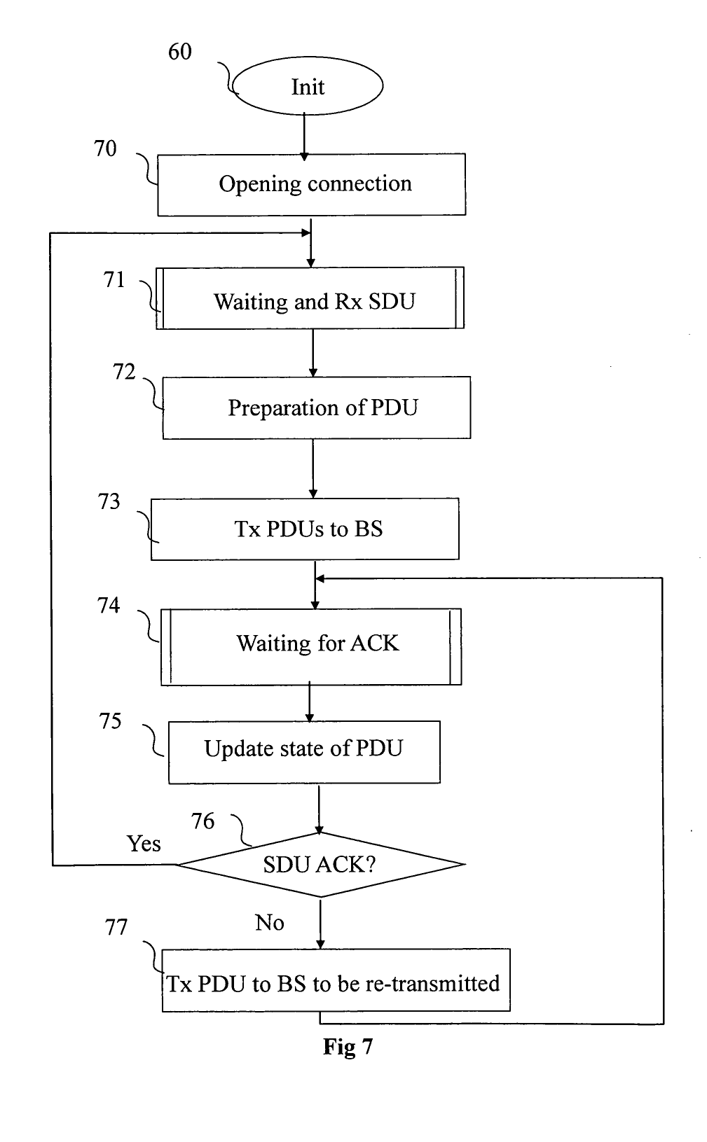

FIG. 7 shows a method implemented in the wireless station 3 according to a particularly advantageous implementation of the invention, in the context of a wireless network comprising notably subscriber stations 11 to 13, compatible with the IEEE 802.16 standard. The steps in common with the method illustrated in FIG. 7 have the same references and are not described in further detail.

After an initialisation step 60, during a step 70, a connection is opened with the base station. A CID is associated with each upward or downward connection between an SS and a BS. Hence, each CID identifies precisely a connection between an SS and a BS as well as the downward or upward direction (two separate connections therefore have a different CID). According to a variant, the CID is the same for the upward and downward direction.

Then, during a step 71, the station 3 waits for and receives at least one SDU from the source 14. The source 14 transmits to all the SSs, the SDU to be transmitted to the base station.

Then during a preparation step of PDU 72, the station 3 divides the SDU received into PDUs, and numbers them for identification. The SSs divide and number the PDUs in the same way so that identical data transmitted by the SSs are in the PDUs that carry the same numbers. An “non-transmitted” status type is associated with each PDU. This step is implemented at any moment so as not to lose the synchronization with the other SSs and notably when the transmission buffer is full (in this case, the division of new SDUs and the numbering of PDUs continues, but the PDUs are not memorized. So that the SSs number in an identical way, according to a particular embodiment, the start number can be selected in an identical way and the division of packets also made in an identical way (for example maximum size of data packets is fixed with the PDU comprising data corresponding to a single PDU or the size of PDU data packets is fixed with PDUs that can comprise data from two consecutive SDUs). Thus the numbering of packets remains identical for distinct SSs. These parameters for numbering and division in packets are, for example, defined in the creation of a connection by the BS, the choice of parameters can be made by any entity (notably BS, source equipment, third party equipment (for example, network control application). Hence step 72 is advantageously preceded by a synchronization step between the SSs for numbering the PDUs. This step is advantageously initial (upon creation of a connection). According to a variant, this step is repeated upon request or periodically or during any event (for example detection of a loss of synchronization by the BS, two PDUs received by the BS having the same order number and not comprising the same data, a corresponding re-synchronization of data packet numbering message being transmitted by the BS or SS control equipment), the SS then implements a re-initialization of the numbering of data packets according to the re-synchronization message.

Then, during a step 73, the station 3 transmits the PDUs in one or more bursts to the base station according to a IEEE 802.16 type communication protocol. The status associated with each PDU is updated by becoming the “transmitted” type.

Then, during a step 74, the station 3 waits for a cumulative and/or selective acknowledgement from the base station recipient of the PDUs. This acknowledgement may be positive (ACK) or negative (NACK). According to a variant, the station 3 launches a timeout during step 73 and the running out of this timeout corresponds to the reception of a NACK. During this step, the station 3 can also receive a synchronization order, in this case, it updates all the waiting PDUs, considering them as acknowledged to empty the corresponding buffer and recommence transmitting the next PDUs with a number synchronized with the other SSs, in this way, the ARQ window in transmission is also synchronous with the reception ARQ window in the BS.

According to a particular embodiment, the SS implements a synchronization timeout for the associated connection and an ARQ transmission window that defines the first non-acknowledged PDU. If the first non-acknowledged PDU changes, then the SS re-initializes the associated synchronization timeout. Then the SS verifies that the synchronization timeout has reached a determined limit value (for example 100 ms). If this is the case (limit timeout value reached), the station 3 waits for a re-synchronization order transmitted by the BS (while continuing to divide the SDUs into PDUs and numbering the PDUs, without keeping them in the memory or transmitting them). The transmission of PDUs recommences after reception of the re-synchronization order.

According to a variant, the station 3 does not implement the synchronization timeouts.

According to a variant implementing the exchanges between the SSs via any channel (for example, via the wired network 15), each SS transmits to the other SSs the acknowledged state (positively) on non-acknowledged stat by reception of a NACK transmitted by the BS (aside from timeout running out, this latter may be due to the non-reception of a transmitted ACK), of the PDUs transmitted previously. The transmission of acknowledgements is performed advantageously in cumulative form. Hence, according to this variant, step 74 takes account of acknowledgement information from the base station and the other SSs.

Then, during a step 75, the station 3 updates the PDUs:
status “to be transmitted” for non-acknowledged or negatively acknowledged PDUs, and
status “received” for positively acknowledged PDUs.

Then, during a test 76, the station 3 checks whether all the PDUs or SDUs received are acknowledged. If this is the case, the step 71 is repeated.

If this is not the case, the PDUs for which the status is “to be retransmitted” are again transmitted to the BS and step 74 is repeated.

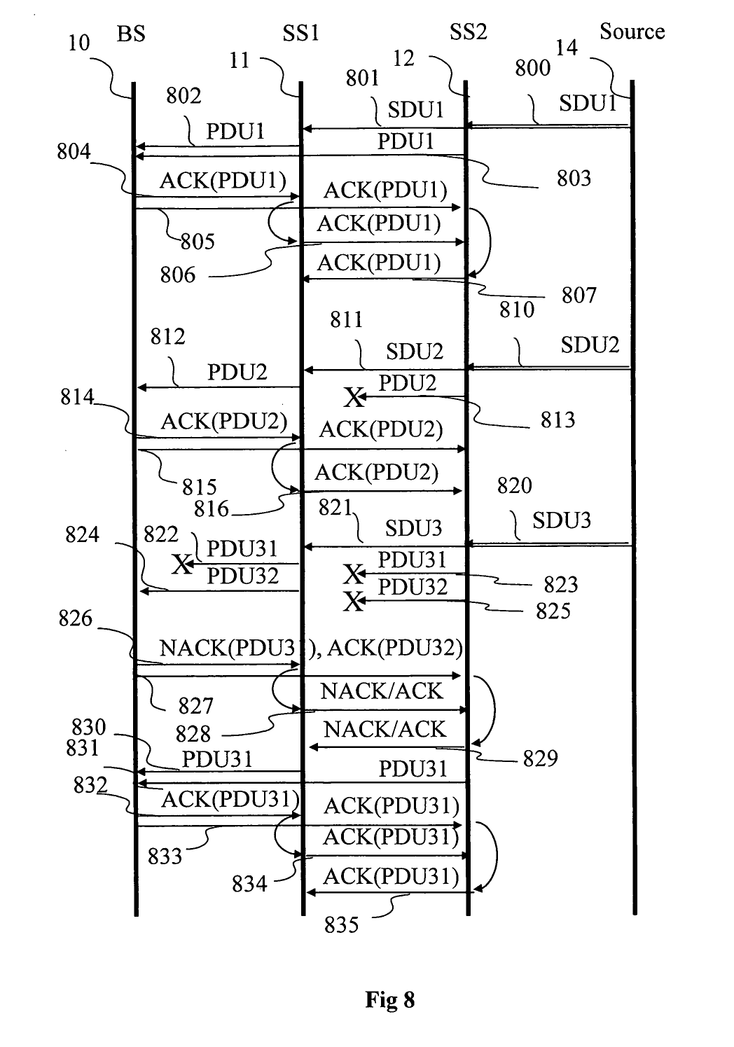

FIG. 8 illustrates an example of communication between the base station 10, the subscriber stations 11 and 12 and the source 14 (these elements are represented by vertical lines; the actions, events and/or successive transmissions are illustrated chronologically). In order to facilitate the reading of the example, only two subscriber stations 11 and 12 are mentioned. The example can be extrapolated to any number of base stations and subscriber stations.

The source 14 transmits signals 800 and 801 comprising an SDU to each of the subscriber stations 11 and 12. As an example, it is the same source 14 which receives or transmits the data coming from or destined for the base station 10. According to FIG. 8, the SDUs are transmitted to the subscriber stations in the form of separate frames with a recipient address corresponding to a unique SS (unicast). According to a variant, the signals 800 and 801 are advantageously combined into one single signal (signal broadcast to all the SS (multicast)).

Then, the SSs 11 and 12 transmit the corresponding PDUs (respectively 802 and 803) to the base station 10. In order to facilitate the reading of the diagram, it is assumed that the PDUs corresponding to the SDU 800 or 801 are transmitted in a single burst.

According to a first scenario, it is assumed that the PDUs 802 and 803 are received correctly by the base station 10. They are acknowledged by the base station 10 that transmits a positive acknowledgement (804 and 805) to each of the SSs. Each positive or negative acknowledgement transmitted by the base station comprises the CID and the number of the PDU or PDUs (with, if necessary, an indication of selective or cumulative acknowledgement). According to FIG. 8, the acknowledgements are transmitted to subscriber stations in the form of distinct frames with a destination address corresponding to a single SS (unicast). According to a variant, the signals 804 and 805 are advantageously combined into one single signal (signal broadcast to all the SS (multicast)) that comprises the CIDs and the number of the of the PDU or PDUs.

Then, according to a variant implementing the acknowledgement exchanges between the SSs, the station 11 (respectively 12) transmits to the other SSs an acknowledgement 806 (respectively 807) on reception of the acknowledgement 804 (respectively 805) transmitted by the BS. Each positive or negative acknowledgement transmitted by an SS comprises the CID and the number of the PDU or PDUs (with, if necessary, a selective or cumulative acknowledgement identification).

According to a second scenario, the source 14 transmits the signals 810 and 811 comprising an SDU to each of the subscriber stations 11 and 12.

Then, the SSs 11 and 12 transmit the corresponding PDUs (respectively 812 and 813) to the base station 10. It is assumed that only the PDU 812 is correctly received by the base station 10. It is therefore acknowledged by the base station 10 that transmits a positive acknowledgement to each of the SSs (respectively 814 and 815). Thus, even if the burst 813 is not received by the base station 10, this burst contains the same PDU as the burst 812, an acknowledgement of this PDU is transmitted to the SS 12.

It is assumed that the acknowledgements 814 and 815 are correctly received by the SS respectively 11 and 12. In an embodiment not implementing the exchanges between SSs, and if the acknowledgement 815 is not received by the SS 12, the SS12 will retransmit the PDU present in the burst 803 until expiration of the timeout, a maximum number of transmissions performed or the reception of a positive acknowledgement (case not shown in FIG. 8).

Then, according to a variant implementing the acknowledgement exchanges between the SSs, the station 11 transmits to the other SSs an acknowledgement 816 on reception of the acknowledgement 814 transmitted by the BS.

According to a third scenario, the source 14 transmits the signals 820 and 821 comprising an SDU (SDU3) to each of the subscriber stations 11 and 12.

This SDU is divided into PDUs transmitted in distinct bursts (PDU31 and PDU32) by the SSs. The SSs first transmit the bursts respectively 822 and 823 comprising a first set of one or more PDUs (PDU31) extracted from the SDU received (SDU3) then the bursts respectively 824 and 825 comprising a second set of one or more PDUs (PDU32) extracted from the SDU received (SDU3).

As an example, it is assumed that a single burst 824 is correctly received by the station 10. The base station 10 then transmits a positive acknowledgement for the second set of PDUs (PDU32) and negative for the first set of PDUs (PDU31) in a burst 826 (respectively 827) to the SS 11 (respectively 12).

In assuming the acknowledgements to be correctly received, according to a variant implementing the acknowledgement exchanges between the SSs, the station 11 (respectively 12) transmits to the other SSs an acknowledgement 828 (respectively 829) on reception of the acknowledgement 826 (respectively 827) transmitted by the BS.

The SSs then again transmit to the base station 10 the bursts 830 and 831 comprising the first set of negatively acknowledged PDUs (PDU31). In assuming these bursts correctly received, they are acknowledged in a similar way to the first scenario with the bursts 822 and 823 (then the frames 834 and 835 according to the variant).

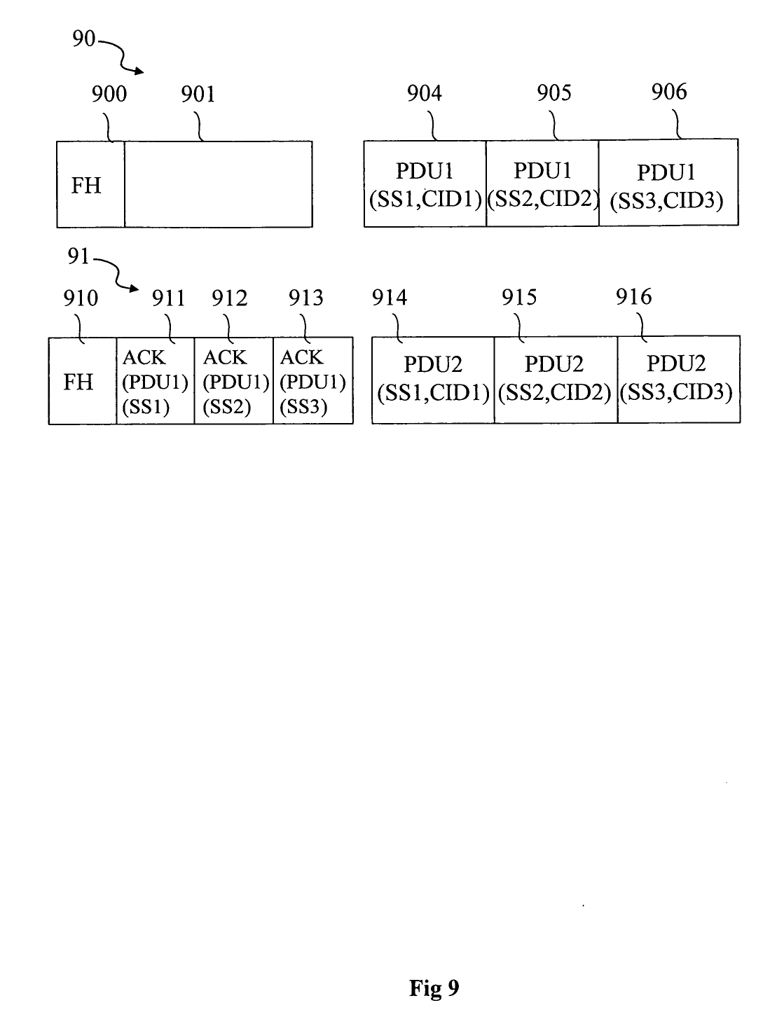

FIG. 9 chronologically illustrates the transmission and reception of successive frames 90 and 91. The frame 90 (91 respectively) is divided into two intervals corresponding respectively to the “downlink” direction, base station to SS and in the “uplink” direction, SS to base station.

The slot 90 comprises:
one part reserved for frame headers in the time slots assigned to each BS,
one part reserved for the transmission of data to the SS or SSs connected in the time slots assigned to each BS,
one part (not shown) enabling exchanges in contention mode (notably to enable the non-associated or non-connected SSs to do it), and
one part reserved for the transmission of data to the BS from the SS connected, in the time slots assigned to each SS.

In the first part of the slot 90, the base station transmits or receives firstly a frame header or FH 900. The attribution of slots for the FH is unremarkable (for example determined according to the MAC address of the BS or to the declaration order in the network). When an SS is associated to a BS, the BS receiving the association demand allocates in a unequivocal manner the time resources for the transmission and/or the reception of data packets. A time resource is assigned to a single SS. A CID is associated with each upward or downward connection between an SS and a BS. Hence, each CID identifies precisely a connection between an SS and a BS as well as the downward or upward direction (two separate connections therefore have a different CID). According to one variant, the CID is the same for the upward and downward direction.

Then, the base station transmits a frame 901 to the SSs.

Next, each of the SSs 12, 13 and 14 successively transmits a burst respectively 904 to 906 containing the same PDU (PDU1) to the base station.

The next frame 91 also comprises a header 910 similar to the header 900.

Then, the frame 91 comprises the acknowledgements 911 to 913 of the PDU or PDUs correctly received by the base station 10, of each of the SSs respectively 11 to 14. According to a variant not shown, the acknowledgements are grouped into a single burst addressed in “multicast” to all the SSs.

Next, each of the SSs 12, 13 and 14 successively transmits a burst respectively 914 to 916 containing the same PDU (PDU2) to the base station.

Naturally, the invention is not limited to the embodiments previously described.

In particular, the architecture of the mobile stations and base stations can be different from those illustrated in FIGS. 2 and 3, in the respective function and/or form of the elements (the functions of the electronic elements can notably be grouped into a restricted number of components or, on the contrary, extended into several components) and their layout.

The invention is not limited to an architecture as described with respect to FIG. 1 but involves any architecture implementing a wireless network with local (for example a few tens of metres) or remote (for example a few kilometres according notably to a standard IEEE 802.16) coverage with one or more SS, each SS being connected at any time to at least one BS. According to one variant, the link between the SSs and/or between the SSs and the source node is a wireless link (local or remote link).

The invention can also be applied with different communication protocols than those described above. Hence, the application and/or control data can be transmitted according to any protocol (for example with a contention access or in polling mode) on the wireless links. The communication channels between the SS and the BS can use the same frequency channels for the upward and downward directions (mode known as “half duplex”) or different frequency channels (mode known as “full duplex”). The network or the links connecting the source to the SSs can also be unremarkable and is not limited to an Ethernet network. This means, for example, a standardised or proprietary protocol, wired or wireless enabling the data transmission from the source to each of the SSs.

Moreover, the packets (SDU) transmitted by a source to the subscriber stations are advantageously and not necessarily divided into small packets (PDU) of MAC level. In the examples given previously the boundaries between SDU and PDU coincide. According to the variants of the invention, they do not coincide. According to other variants, a PDU can correspond to one or more SDUs.

The subscriber stations are advantageously unremarkable stations compatible with the IEEE 802.16 standard. According to the variants of the invention, they comprise one part linked to wireless exchanges compatible with the IEEE 802.16 standard and one dedicated part aiming to improve the quality of service (for example, one part allowing the acknowledgements exchanged between subscriber stations to be managed).

The architecture of the base station is also not limited to the examples previously described. In particular, according to different embodiments, the application part of the base station (for example, data processing unit (notably voice and/or images), a camera control unit, etc.) can be integrated in an item of equipment comprising the radio and communication management part on the wireless link with the subscriber stations, or, on the contrary, separated completely or partly from this item of equipment. According to a particular embodiment, the application part of the base station is in a separate device from the communication part with the SSs: for example, the BS receives a video flow transmitted on Ethernet (or on a different wired or wireless link, following a standard protocol or proprietor) to a digital recorder, a screen or a computer.

Likewise, the architecture of the subscriber station is also not limited to the examples previously described. In particular, according to different embodiments, the data source (for example, data processing unit (notably voice and/or images), an application control unit associated with the base station or stations, etc.) can be integrated in an item of equipment comprising the radio and communication management part on the wireless link with the base stations, or, on the contrary, separated completely or partly from this item of equipment.

According to a variant of the invention, a same PDU is not transmitted by all the SSs but by a sub-set (for example, to one or more SSs for which there is a good quality link with the BS (typically the SSs whose PDUs are correctly received by the BS)). Advantageously, for each PDU correctly received by the BS, the BS transmits to each of the SSs a positive acknowledgement, and possibly a negative acknowledgement in the case where a PDU has not been correctly received. In this case, according to this variant, each SS transmits or retransmits the PDU or PDUs not acknowledged positively.

According to a variant of the invention, a SS can be temporarily removed from the SS sub-set communicating with the BS (if, for example the wireless link is bad, the wired link being maintained) reintroduced subsequently (for example when the link becomes satisfactory again) after a resynchronisation of the ARQ windows.

The invention can advantageously be combined with the invention covered by the French patent application FR0755233 filed on the 24 May 2007 by Thomson Licensing and entitled “Data packet reception method and corresponding transmission method”. In an architecture similar to the network of FIG. 1, the latter provides for the transmission of data packets by a BS to the SSs. Each data packet is thus transmitted on several links between the BS and the SSs. Each SS transmits to the BS an acknowledgement indicating that it has correctly received the corresponding packet. When a packet has not been acknowledged by at least one SS, the BS transmits it to the SS again. In particular, the BS and SS of the network of FIG. 1 can advantageously implement both a transmission and a reception combining the invention covered by the present application and the invention covered by the application mentioned earlier.

1. Method for reception of data packets, the method being implemented in a first station, each packet data unit being transmitted by at least two second stations intended for the first station, said second stations belonging to a set comprising more than one second stations, wherein the method comprises a transmission of at least one acknowledgement of each data packet, said packet being received at least once correctly, said acknowledgement(s) being transmitted to each second station of said set,
the packets of data being from at least one service packet unit (SDU), the division and numbering of said at least one data packet by each of said second stations being identical.

2. Method according to claim 1, wherein it comprises a request for retransmission of at least one data packet to at least one of the second stations, when said data packet(s) have not been correctly received.

3. Method according to claim 2, wherein it comprises a request for retransmission of at least one data packet to at least one of the second stations, when said data packet(s) have not been correctly received.

4. Method according to claim 1, wherein said packet or packets of data are in the medium access control communication layer called the MAC layer.

5. Method according to claim 1, wherein it comprises a step of assembly of several packets received in a service packet unit (SDU).

6. Method according to claim 1, wherein the data packets received come from at least two distinct stations.

7. Method according to claim 1, wherein each data packet is transmitted to the first station by each of said second stations.

8. Method according to claim 1, wherein each data packet is transmitted on a wireless link between the second stations and the first station.

9. Method according to claim 8, wherein each data packet is transmitted according to an IEEE 802.16 protocol between the second stations and the first station.

10. Method according to claim 1, wherein it comprises a transmission to a device of at least one service packet comprising the data corresponding to a received data packet, said at least one service packet comprising the control information of said device.

11. Method according to claim 1, wherein it comprises a transmission to a device of at least one service packet comprising the data corresponding to at least one received data packet, said device being adapted to capture audiovisual data.

12. Method according to claim 1, wherein it comprises a detection of a loss in synchronization in the numbering of data packets received and the transmission of a packet numbering re-synchronization message.

13. Method for the transmission of data packets to a first station, the method being implemented in a second station, each packet being transmitted by at least two second stations to a first station, wherein the method comprises:
a division of at least one service packet unit into at least one packet data unit by said at least two second stations, the division and numbering of the data packet(s) being identical in each of said second stations,
a transmission of said at least one data packet intended for said first station, and
a reception of a first acknowledgement of at least one data packet transmitted, said acknowledgement being transmitted by said first station.

14. Method according to claim 12, wherein at least one of said second stations transmits a second acknowledgement corresponding to said first acknowledgement to each of the other second stations.

15. Method according to claim 13, wherein it comprises the reception of a data packet numbering resynchronization message, and a re-initialization of the data packet numbering according to said resynchronization message.
